(19) United States
(12) Patent Application Publication
(10) Pub. No.: US 2024/0131823 A1
(43) Pub. Date: Apr. 25, 2024

(54) OPTICAL INTERLAYERS AND METHODS OF MAKING THE SAME

(71) Applicant: DelStar Technologies, Inc., Alpharetta, GA (US)

(72) Inventors: Dave Collette, South Hadley, MA (US); Joseph Moriarty, Southampton, MA (US)

(21) Appl. No.: 18/483,063

(22) Filed: Oct. 8, 2023

Related U.S. Application Data
(60) Provisional application No. 63/419,259, filed on Oct. 25, 2022.

(51) Int. Cl. B32B 17/10

(52) U.S. Cl. CPC B32B 17/10935; B32B 17/10036; B32B 17/10587; B32B 17/1077; B32B 17/10788; B32B 2250/03; B32B 2250/40; B32B 2307/40; B32B 2331/04; B32B 2375/00

(57) ABSTRACT

Optical interlayers, laminated composites and improved methods for manufacturing the optical interlayers and laminated composites are provided. An optical interlayer film comprises at least one surface having an embossed surface pattern having at least two channels extending in at least two non-parallel directions. The channels have a depth of greater than about 20 μm. The surface pattern allows for the removal of air between the interlayer and the outer laminate sheets, thereby establishing the requisite seal therebetween while minimizing premature edge sealing. The laminated composites are particularly useful for safety glazing in a variety of applications, such as automobiles, airplanes, trains, or other modes of transportation, display devices, windows in homes and other buildings, building facades, cabinets, and/or weight bearing architectural structures such as stairs and floors.

### CROSS-REFERENCE TO RELATED APPLICATIONS

This application claims the benefit of U.S. Provisional Application Ser. No. 63/419,259, filed Oct. 25, 2022, the complete disclosure of which is incorporated herein by reference for all purposes.

### FIELD

This description generally relates to optical interlayers and laminated composites, such as laminated safety glass, and methods for manufacturing such interlayers and composites.

### BACKGROUND

Glass has been widely used in various buildings, vehicles and display devices due to its transparency, airtightness, high strength and hardness. In order to enhance the safety and applicability of glass, it is customary to place a sheet or film of thermoplastic interlayer material between two pieces of the glass. When such a laminated glass is subjected to an external impact, the glass may break up, but the interlayer sandwiched between the component glass sheets will not readily be destroyed. Even after breakage, the glass remains glued to the interlayer so that its fragments will not be scattered. Therefore, the bodies of any individuals in the vehicle or building are protected against injury from fragments of the broken glass.

Laminated glass is usually manufactured by interposing the interlayer between the two glass sheets, drawing the assembly over a nip roll or placing it in a rubber bag and evacuating the bag to effect preliminary contact bonding between the glass sheets and the interlayer. Final contact bonding is then carried out at elevated temperature and pressure in an autoclave.

The interlayer material is typically roughened or embossed with a surface pattern to minimize one layer sticking to another. In addition, this surface pattern can allow the interlayer to be moved while the two pieces of glass are aligned as the assembly is constructed. Unfortunately, this roughening of the interlayer surfaces causes air to be trapped in the interstitial space between the glass surface and the bulk of the thermoplastic interlayer.

Trapped air can be removed either by vacuum de-airing or by nipping the assembly between a pair of rollers. The degree to which air must be removed from between the glass and the interlayer will depend on the nature of the interlayer and the intended application. The presence of a gaseous phase within the laminate will take the form of bubbles or pockets of gas between the interlayer and glass interface. These bubbles or pockets of gas may increase the haze and/or reduce the light transmittance of the laminate, thereby rendering the laminate suboptimal for end use applications where the laminate functions as a transparent article, such as safety glass or similar applications.

For certain applications, laminators have encountered challenges when selecting a suitable interlayer and a suitable surface pattern for the interlayer. For example, interlayers which have rougher surfaces can allow for faster de-airing. However, such interlayers can make it difficult to obtain adequate edge seal as more energy is generally required to compact the rough interlayer. If the edges of the pre-press are not completely sealed, air can penetrate the edge in the autoclaving step where the pre-press is heated under high pressure, and can cause visual defects in the laminate which is commercially unacceptable. In addition, interlayers that are rough and allow for rapid de-airing at about room temperature (23° C.) often do not de-air as well when the ambient temperature is much above 30° C.

On the other hand, relatively smooth interlayers can lead to the edges sealing before sufficient air is removed, and can leave air trapped inside the pre-press. This problem is commonly referred to as premature edge seal, and can be especially common with plasticized interlayers, such as PVB. During autoclaving, the excess air may be forced into solution under high pressure, but may return to the gas phase after autoclaving. Defects which occur after lamination are often more costly to rectify.

It would be desirable to provide improved optical interlayers that have roughened and/or embossed surfaces that allow for the removal of air trapped between the interlayer and the outer sheets of the laminate composite. In particular, it would be desirable to provide embossed or roughened surfaces that provide the requisite seal between the interlayer and the outer sheets, while minimizing premature edge sealing that would otherwise leave air or gas trapped in the interstitial spaces between the interlayer and the outer sheets.

### SUMMARY

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Optical interlayers, laminated composites and methods for manufacturing the interlayers and composites are provided. In various embodiments, the optical interlayers described herein have embossed or roughened surfaces that allow for the removal of air between the interlayer and one or more outer laminate sheets when the interlayers are used, for example, in a laminate composite. This establishes the requisite seal between the interlayer and the outer sheets, while also minimizing premature edge sealing. In various embodiments, the laminate composites described herein have relatively low haze and high light transmittance and, therefore, are particularly useful for safety glazing in a variety of applications that may require optically transparent laminates, such as windows in automobiles, airplanes, trains, or other modes of transportation, display devices, windows in homes and other buildings, building facades, cabinets, and/or weight bearing architectural structures such as stairs and floors.

In one aspect, an optical interlayer film comprises at least one surface having an embossed surface pattern having at least two channels extending in at least two non-parallel directions. The channels have a depth of greater than about 20 μm.

In various embodiments, the channels have a depth of greater than about 30 μm or about 30 μm to about 50 μm, preferably about 35 μm to about 43 μm. The channels may have a width of about 30 μm to about 900 μm or about 400 μm to about 600 μm. The width may be measured, for example, from a midpoint of the depth of the channels.

The interlayer may comprise a non-plasticized or plasticized thermoplastic material. In certain embodiments, the interlayer comprises a non-plasticized thermoplastic material. Suitable thermoplastic materials include polyurethane interlayers, ethylene vinyl acetate interlayers, ethylene acid copolymer interlayers, ionoplastic material or combinations thereof. In an exemplary embodiment, the material comprises a non-plasticized thermoplastic polyurethane (TPU).

The interlayer film may have a second surface opposite the first surface. The second surface has an embossed surface pattern having at least two channels extending in at least two non-parallel directions. The channels have a depth of greater than about 20 μm, or greater than about 30 μm. The second embossment pattern may be the same or different from the first embossment pattern. For example, the embossing pattern and/or the depth thereof can be asymmetric with respect to the two sides of the interlayer film.

The channels may be formed by embossing projections onto the base surface of the interlayer film. In some embodiments, depressions or voids are also formed into the base surface. This configuration reduces the energy required to flatten the interlayer between, for example, two rigid sheet in a laminate. In these embodiments, the depth of the channels is measured from the peak of the projections to the lowest point or valley of the depressions.

In various embodiments, the embossment pattern comprises a first plurality of channels extending in a first direction and spaced from each other by a distance of about 100 μm to about 1,000 μm and a second plurality of channels extending in a second direction and spaced from each other by a distance of about 100 μm to about 1,000 μm. The first set of channels extend in a direction that is non-parallel to second set of channels. In an exemplary embodiment, the first set of channels are substantially perpendicular to the second set of channels.

The optical interlayer film may have a thickness of less than about 0.08 inches. In certain embodiments, the thickness is less than about 0.02 inches or about 0.014 to about 0.017 inches, or about 0.15 inches. In embodiments, the embossed surface(s) of the interlayer film have an 85° degrees Gloss of about 14 to about 20, or about 15 to about 17.

The optical interlayer films provided herein are particularly useful for laminates that include first and second substantially rigid sheets on either side of the interlayer film. The rigid sheets may include rigid plastic materials, such as polycarbonate, and/or glass. The embossed surface pattern on the interlayer provides a plurality of substantially uninterrupted channels for de-airing between the interlayer and the outer rigid sheets in at least two directions. The depth of the channels allows air to escape during the lamination process without prematurely sealing the edges of the interlayer to the glass. The resulting laminate has sufficiently low haze and high light transmittance to function as safety glass for a variety of applications.

In another aspect, a laminate comprises at least one layer of glass and an interlayer film bonded to the layer of glass. The interlayer film comprises at least one surface facing the layer of glass and having an embossed surface pattern with at least two channels extending in at least two non-parallel directions. The channels have a depth of greater than about 20 μm, or greater than about 30 μm, prior to lamination.

In various embodiments, the laminate comprises a second layer of glass, wherein the interlayer film is positioned between the first and second layers of glass. The interlayer film may have a second surface opposite the first surface and facing the second layer of glass. The second surface has an embossed surface pattern having at least two channels extending in at least two non-parallel directions. The channels have a depth of greater than about 20 μm, or greater than about 30 μm, prior to lamination.

In various embodiments, the interlayer comprises a non-plasticized thermoplastic material. Suitable thermoplastic materials include polyurethane interlayers, ethylene vinyl acetate interlayers, ethylene acid copolymer interlayers, ionoplastic material or combinations thereof. In an exemplary embodiment, the material comprises non-plasticized TPU.

In various embodiments, the laminate has a relatively low haze after lamination (as measured by ASTM D1003) of about 0.8% to about 0.9%, or about 0.82% to about 0.86%, or about 0.84%.

In various embodiments, the laminate has a relatively high light transmission after lamination (as measured by ASTM D1003) of about 85% to about 95% or about 89% to about 90%.

The laminates may include a single optical interlayer film or multiple interlayer films sandwiched between the outer rigid sheets (i.e., glass or polycarbonate). In the latter embodiment, each of the interlayer films may include surface patterns, such as those described above, on one or both sides of the interlayer film.

In another aspect, a method of manufacturing an optical interlayer film comprises forming an embossment pattern on a calendar roll and transferring the embossment pattern to a surface of an optical interlayer film such that the surface has at least two channels extending in at least two non-parallel directions and the channels have a depth of greater than about 20 μm.

In various embodiments, the calendar roll may comprise metal, rubber or a combination thereof. In an exemplary embodiment, the calendar roll includes a metal roll and a rubber roll. The metal roll is engraved with the surface pattern and pressed against one surface of the interlayer, while the rubber roll is pressed against the opposite surface of the interlayer.

In embodiments, the method further comprises transferring a second embossment pattern to a second surface of the interlayer film opposite the first surface. The second embossment pattern may be the same or different from the first embossment pattern. In an exemplary embodiment, the second embossment pattern has at least two channels extending in at least two non-parallel directions and the channels have a depth of greater than about 20 μm.

The method may further comprise placing the optical interlayer film between first and second sheets of glass to obtain a laminated structure and vacuum laminating the laminate structure to remove air trapped between the interlayer film and the glass sheets.

The recitation herein of desirable objects which are met by various embodiments of the present description is not meant to imply or suggest that any or all of these objects are present as essential features, either individually or collectively, in the most general embodiment of the present description or any of its more specific embodiments.

### BRIEF DESCRIPTION OF THE DRAWINGS

FIG. 1 is a graphical depiction of a surface pattern on one surface of an optical interlayer;

FIG. 2 is a top view depiction of a surface pattern of an optical interlayer as measured along a diagonal line across the interlayer;

FIG. 3 is a graph illustrating the height and width of channels along the diagonal line of FIG. 2; and

FIG. 4 is a graph illustrating the frequency distribution of the S t or peak height of the channels formed in the surfaces of multiple optical interlayers.

### DETAILED DESCRIPTION OF THE EMBODIMENTS

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Optical interlayers and laminated composites, such as safety glass laminates and the like, are provided. In addition, improved methods for manufacturing the optical interlayers and laminated composites are provided. Various embodiments of the systems and methods described herein have embossed or roughened surfaces that allow for the removal of air between the interlayer and the glass, thereby establishing the requisite seal therebetween while minimizing premature edge sealing.

The optical interlayers described herein are thermoplastic interlayers that can be heated and be caused to form an adhesive bond with other interlayer materials, with rigid plastic materials, and/or with glass. Laminates comprising interlayers described herein are particularly useful as safety glazing in a variety of applications. For example, these laminates can be suitable for use in automobiles, airplanes, trains, or other modes of transportation comprising windows or transparent apertures wherein safety glazing can be used to protect the occupants or contents of the vehicle. Other suitable applications for safety glazing are well known, including for example, windows in homes and other buildings, building facades, cabinets, weight bearing architectural structures such as stairs and floors for example.

The appearance and transparency of transparent laminates is an important feature in assessing the desirability of using said laminates. One factor affecting the appearance of said laminates is whether the laminate includes trapped air or air bubbles that develop between the interlayer and the surface of the glass, for example. It is desirable to remove air in an efficient manner during the lamination process.

Providing channels for the escape of air and removing air during lamination is a known method for obtaining laminates having acceptable appearance. This can be effected by mechanically embossing the interlayer sheet (or by melt fracture during extrusion) followed by quenching so that the roughness is retained during handling. Retention of the surface roughness is essential to facilitate effective deaeration of the entrapped air during laminate preparation

The interlayer comprises a non-plasticized or plasticized thermoplastic material. In certain embodiments, the material is non-plasticized. Suitable thermoplastic materials include polyurethane interlayers, ethylene vinyl acetate interlayers, ethylene acid copolymer interlayers, ionoplastic material and the like. In an exemplary embodiment, the material comprises a non-plasticized thermoplastic polyurethane (TPU). TPU is any of a class of polyurethane plastics with many properties, including elasticity, transparency, and resistance to oil, grease and abrasion.

The surface pattern is preferably an embossed pattern. The channel depth is from about 20 μm to about 80 μm. Preferably, the channels have a depth of greater than about 30 μm or about 30 μm to about 50 μm, preferably about 35 μm to about 43 μm. The depth is preferably selected so that the regular channels provide suitable paths for air to escape during the lamination process. It is desirable therefore that the depth be sufficiently deep that the air pathways are not cut off prematurely during the heating stage of the lamination process, leading to trapped air in the laminate when it cools.

An interlayer sheet can be embossed on one or both sides. The embossing pattern and/or the depth thereof can be asymmetric with respect to the two sides of an interlayer sheet. That is, the embossed patterns can be the same or different, as can be the depth of the pattern on either side of the sheet. In a preferred embodiment, an interlayer sheet of the present invention has an embossed pattern of each side wherein the depth of the pattern on each side is greater than about 20 μm. In certain embodiments, there is an embossed pattern on one side of the interlayer sheet that is orthogonal to the edges of the sheet, while the identical embossed pattern is slanted at some angle that is greater than or less than 90° to the edges, and the depth of said embossed patterns is greater than about 20 micrometers. Offsetting the patterns in this manner can eliminate an undesirable optical effect in the sheeting.

The channel width may be measured from the hallway point between the top and bottom of the channels (i.e., half the distance between the valley depth and the peak height as discussed below). The channels may have a width at this halfway point of about 30 μm to about 900 μm or from about 400 μm to about 600 μm.

In embodiments, the embossment pattern comprises a first plurality of channels extending in a first direction and spaced from each other by a distance of about 100 μm to about 1,000 μm or about 300 μm to about 800 μm, preferably between about 500 μm to about 700 μm. The embossment pattern may include a second plurality of channels extending in a second direction and spaced from each other by a distance of about 100 μm to about 1,000 μm or about 300 μm to about 800 μm, preferably between about 500 μm to about 700 μm. The first channels extend in a direction that is non-parallel to second channels. In an exemplary embodiment, the first channels are substantially perpendicular to the second channels.

Of course, it will be recognized that other patterns may be formed in the interlayer. For example, the surface pattern may include three or more different sets of channels that extend in three or more directions.

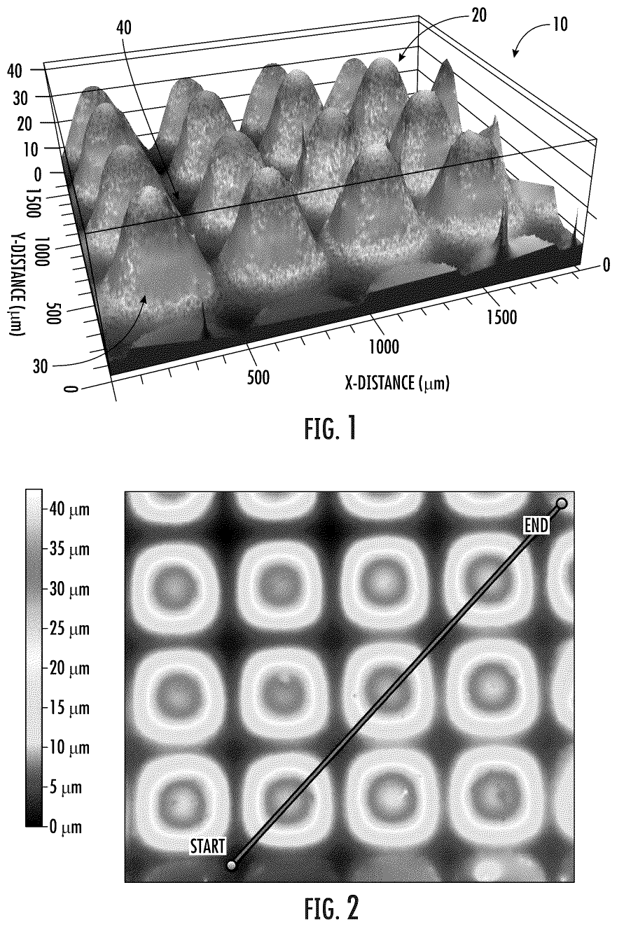

Referring now to FIG. 1, an example of a surface pattern on an optical interlayer 10 provided herein having a base surface 30 which generally represents the original substantially flat surface of the interlayer prior to formation of the surface pattern. The surface pattern comprises projections 20 upward from base surface 30 as well as voids, or depressions 40, in the interlayer surface 30. Such projections 20 and depressions 30 may have different volumes, or they may have substantially the same volume, and they are located in close proximity to other such projections and voids on the interlayer surface.

The projections and depressions are preferentially located such that heating and compressing the interlayer surface results in more localized flow of the thermoplastic material from an area of higher thermoplastic mass (that is, a projection) to a void area (that is, depression), wherein such voids would be filled with the mass from a local projection, resulting in the interlayer surface being flattened. Localized flow of the thermoplastic resin material to obtain a flattened surface would require less of an energy investment than a more conventional pattern (i.e., one having only projections and no depressions), which require flattening of a surface by effecting mass flow of thermoplastic material across the entire surface of the interlayer.

In an alternative embodiment, the surface pattern includes only projections (i.e., no depressions). In this embodiment, the channel depth is measured from the base surface 30 to the top of projections 30.

The optical interlayer film may have a thickness of less than about 0.08 inches. In certain embodiments, the thickness is less than about 0.02 inches or about 0.014 to about 0.017 inches, or about 0.15 inches.

In one embodiment, the average peak height or Sp of each projection ranges from about 5 μm to about 50 μm, or about 20 μm to about 40 μm, preferably between about 25 μm to about 30 μm. The average depth of each void or depression or ranges from about 5 μm to about 40 μm, or about 10 μm to about 20 μm, preferably about 12 μm to about 16 μm. Thus, the average height of each channel (i.e., distance from peak height to valley depth) is greater than about 30 μm or about 30 μm to about 50 μm, preferably about 35 μm to about 43 μm.

The kurtosis of the surface pattern (i.e., the measure of the combined weight of a distribution's tails relative to the center of the distribution) is preferably less than about 5.0, or less than about 3.0. The skewness (i.e., the measure of the a symmetry of the probability distribution of the height about its mean) of the surface pattern is preferably between about 0.8 to about 0.85.

One example of a peak height and valley depth of a surface pattern is shown in TABLE 1 below.

TABLE 1

| | | | |
|---|---|---|---|
| Sₚ | 28.1 | μm | Peak height |
| Sᵥ | 14.33 | μm | Valley depth |
| Sₜ | 42.43 | μm | Maximum peak to valley height |
| Sₐ | 7.95 | μm | Arithmetic mean height |
| S_{q} | 9.487 | μm | Root mean square height |
| Sₛₖ | 0.8216 | | Skewness |
| Sₖᵤ | 2.551 | | Kurtosis |

As shown above in TABLE 1, the arithmetic mean height to S a of this sample was about 7.95 μm and the root mean square height was about 9.487 μm. The kurtosis (i.e., the measure of the combined weight of a distribution's tails relative to the center of the distribution) was about 2.551 and the skewness (i.e., the measure of the asymmetry of the probability distribution of the height about its mean) was about 0.8216.

The surface pattern produced on the interlayers increases the gloss of these surfaces. In one embodiment, the 85° degree gloss of the embossed surfaces of the interlayer is between about 12 to about 20, or about 15 to about 17. In certain embodiments, the embossed surface pattern increases the 85° degree gloss of the interlayer by about 10 to about 15, or about 12 to about 13.

The optical interlayer film is particularly useful for laminates that include first and second substantially rigid sheets on either side of the interlayer film. The rigid sheets may include rigid plastic materials, such as polycarbonate, and/or glass. In one embodiment, the sheets include annealed glass having a thickness of about 2.5 mm to about 5.0 mm, or about 3.0 mm to about 3.5 mm.

The laminates may include a single optical interlayer film or multiple interlayer films sandwiched between the outer rigid sheets (i.e., glass or polycarbonate). In the latter embodiment, each of the interlayer films may include surface patterns, such as those described above, on one or both sides of the interlayer film. In a preferred embodiment, each of the interlayer films will include surface patterns on both sides of the film.

In embodiments, the laminate have a relatively low haze and high light transmission after lamination (as measured by ASTM D1003), which makes them particularly suitable for applications that require optical transparency. In one such embodiment, the haze of the laminates are about 0.8% to about 0.9%, or about 0.82% to about 0.86%, or about 0.84%. The light transmission is about 85% to about 95% or about 89% to about 90%.

A method of manufacturing optical interlayer film will now be described. An embossment pattern is engraved onto a calendar roll through standard techniques, such as mill engraving, etching (e.g., photo engraving) and/or machine engraving. In certain embodiments, the calendar roll may comprise metal, rubber or a combination thereof. In an exemplary embodiment, the calendar roll includes a metal roll and a rubber roll. The metal roll is embossed with the surface pattern and the interlayer is advanced through the rolls such that the metal roll faces one surface of the interlayer and the rubber rolls faces the opposite surface.

The optical interlayer is then fed through the rolls to transfer this surface pattern onto one surface of the interlayer film such that the surface has at least two channels extending in at least two non-parallel directions and the channels have a depth of greater than about 20 μm. The surface pattern on the interlayer may include both peaks that extend above the base surface and depressions that extend below the base surface.

In embodiments, the method further comprises transferring a second embossment pattern to a second surface of the interlayer film opposite the first surface. The second embossment pattern may be the same or different from the first embossment pattern. In an exemplary embodiment, the second embossment pattern has at least two channels extending in at least two non-parallel directions and the channels have a depth of greater than about 20 μm. The interlayer may be passed through a second calendar roll with the metal roll embossing the opposite surface of the interlayer. Alternatively, the interlayer may be turned around such that the opposite surface faces the embossed metal roll.

The method may further comprise placing the optical interlayer film between first and second sheets of a rigid material, such as glass, to obtain a laminated structure and vacuum laminating the laminate structure.

### EXAMPLES

Various sheets of TPU interlayers were manufactured with embossed surface patterns. The surface patterns were first engraved into surfaces of first and second calendar rolls. The calendar rolls included a metal roll and a rubber roll. The surface patterns were embossed into the metal rolls. The thermoplastic polyurethane (TPU) material was fed through the rolls to transfer this surface pattern onto one surface of the interlayer. The surface pattern on the interlayer included both peaks that extend above the base surface and depressions that extend below the base surface.

As shown in TABLE 2 below, six different rolls of interlayer material were provided (Rolls 8-13) and Applicant measured the dimensions of the surface patterns of three different samples from each Roll. The average of these three different samples are presented in TABLE 2. As shown, the depth of each channel (Roll Average S t) was measured as the distance between the peak of each projection to the depth of each void located adjacent the projection. The average of 3 samples from each roll ranged from about 35.92 μm (Roll 13) to about 41.02 μm (Roll 8).

The average 85° degree gloss of the embossed surfaces of the interlayer (i.e., the side facing the metal roll) was between about 15 to 17 (specifically between about 15.04 to about 16.71). By contrast, the average 85° degree gloss of the opposite surfaces of the interlayer (i.e., the side facing the rubber roll) was between about 3.04 to about 3.82. Thus, the embossed surface pattern increased the 85° degree gloss of the interlayer by an average of about 12 to about 13.

As shown in TABLE 2, the average gauge or thickness of the interlayer samples was about 0.015 inches. The minimum thickness was about 0.014 inches and the maximum thickness was about 0.017 inches.

TABLE 2

| | Roll 8 | Roll 9 | Roll 10 | Roll 11 | Roll 12 | Roll 13 |
|---|---|---|---|---|---|---|
| Roll Average Sₜ | 41.02 | 38.87 | 39.96 | 38.12 | 37.56 | 35.92 |
| 85° Gloss Steel | 15.04 | 15.89 | 16.21 | 16.19 | 15.93 | 16.71 |
| 85° Gloss Rubber | 3.04 | 3.33 | 3.43 | 3.35 | 3.41 | 3.82 |
| Haze | 0.84 | 0.84 | 0.84 | 0.84 | 0.84 | 0.84 |
| LT | 89.3 | 89.3 | 89.3 | 89.3 | 89.3 | 89.3 |
| Max gauge | 0.01675 | 0.0169 | 0.01655 | 0.01565 | 0.01655 | 0.0166 |
| Average gauge | 0.01548 | 0.01541 | 0.0155 | 0.01489 | 0.01549 | 0.0152 |
| Min gauge | 0.01415 | 0.0143 | 0.01435 | 0.01405 | 0.0145 | 0.01405 |
| STD Gauge | 0.57363 | 0.61951 | 0.5406 | 0.34024 | 0.51004 | 0.69877 |
| (mils) | | | | | | |

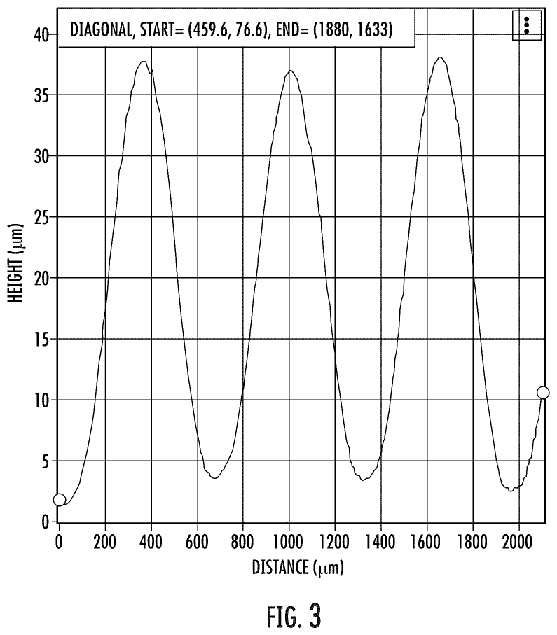

FIGS. 2 and 3 illustrate the line roughness of one of the rolls (ROLL 9). As shown, a diagonal line was traced across the surface of the interlayer and the height was measured along the diagonal line. The base line or “zero μm” height was at the valley floor of each depression or void. As shown, the overall height of each channel or S t was between about 34 μm and about 40 μm. The distance between the peak of each channel was between about 600 μm to about 700 μm and the width of each channel (taken at the mid-point of the channel height) was between about 400 μm to about 600 μm.

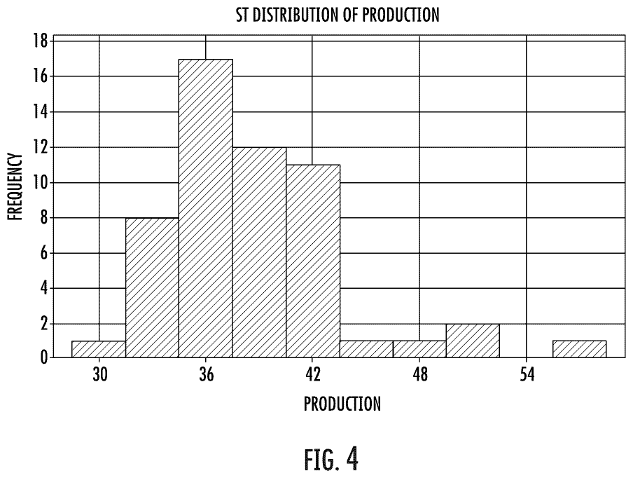

FIG. 4 illustrates the overall frequency of S t values for various interlayers produced by Applicant. As shown, the frequency generally corresponds to a bell curve with the mean or top of the curve having an Sₜ of about 36 μm, and the width or standard deviation of the curve to be about 12 μm (i.e., between about 32 μm and 44 μm). Although the bell curve includes a few outliers, i.e., one interlayer having an S t of about 30 μm and five outliers having an St greater than 42 μm, all of the interlayers produced had a S t of at least 30 μm.

The embossed interlayer material was then placed between two sheets of glass. This sandwich was then vacuum bagged using standard techniques and a vacuum was drawn on the assembly for about 15 minutes at about 28 inches of Hg absolute pressure. After this deairing step, the vacuum-bagged assembly was simultaneously heated and pressurized in an autoclave to a temperature of 239° F. and a pressure of 100 psig respectively over a period of approximately 45 minutes. The laminate was held under these conditions for an additional 15 minutes to ensure polymer melting and bonding to glass substrates. At the end of the holding time, the laminate was depressurized and cooled to ambient conditions to complete the lamination process.

The resulting laminates were essentially clear or transparent with little to no haziness. The haze of the resulting laminate was measured using ASTM D1003 As shown in TABLE 2, all of the laminates had a haze of 0.84%. The light transmission of the resulting laminate was also measured using ASTM D1003. As shown in TABLE 2, all of the laminates had a light transmission of 89.3

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is an optical interlayer film comprising at least one surface having an embossed surface pattern having at least two channels extending in at least two non-parallel directions. The channels have a depth greater than about 20 μm.

A second embodiment is the first embodiment, wherein the depth of the channels is greater than about 30 μm.

A third embodiment is any combination of the first 2 embodiments, wherein the depth of the channels is about 30 μm to about 50 μm.

A 4th embodiment is any combination of the first 3 embodiments, wherein the depth of the channels is about 35 μm to about 43 μm.

A 5^{th} embodiment is any combination of the first 4 embodiments, wherein the channels have a width of about 30 μm to about 900 μm.

A 6^{th} embodiment is any combination of the first 5 embodiments, wherein the channels are formed from one or more projections extending from the surface and one or more depressions extending into the surface, wherein a distance between a peak of the projections and a lowest point of the depressions is greater than about 20 μm.

A 7^{th} embodiment is any combination of the first 6 embodiments, wherein the channels have a width of about 400 μm to about 600 μm.

An 8^{th} embodiment is any combination of the first 7 embodiments, wherein the film comprises a non-plasticized thermoplastic material.

A 9^{th} embodiment is any combination of the first 8 embodiments, wherein the film comprises thermoplastic polyurethane (TPU).

A 10^{th} embodiment is any combination of the first 9 embodiments, wherein the film comprises ethylene vinyl acetate (EVA).

An 11^{th} embodiment is any combination of the first 10 embodiments, further comprising a second surface opposite the first surface, wherein the second surface has an embossed surface pattern having at least two channels extending in at least two non-parallel directions, the channels having a depth of greater than about 20 μm.

A 12^{th} embodiment is any combination of the first 11 embodiments, wherein the film has a thickness of less than about 0.08 inches.

A 13^{th} embodiment is any combination of the first 12 embodiments, wherein the film has a thickness of less than about 0.02 inches.

A 14^{th} embodiment is any combination of the first 13 embodiments, wherein the two channels are substantially perpendicular to each other.

A 15^{th} embodiment is any combination of the first 14 embodiments, further comprising a first plurality of channels extending in a first direction and a second plurality of channels extending in a second direction that is non-parallel to the first direction, wherein the channels within the first plurality of channels are spaced from each other by a distance of about 100 μm to about 1,000 μm.

In another aspect, a laminate is provided comprising a film according to any combination of the first 15 embodiments.

In another aspect, a glass is provided comprising a film according to any combination of the first 15 embodiments.

In another aspect, a window glazing is provided comprising a film according to any combination of the first 15 embodiments.

In another aspect, a first embodiment is a laminate comprising at least one layer of glass; and an interlayer film comprising at least one surface having an embossed surface pattern having at least two channels extending in at least two non-parallel directions. The channels have a depth greater than about 20 μm prior to lamination.

A second embodiment is the first embodiment, wherein the depth of the channels is greater than about 30 μm.

A third embodiment is any combination of the first 2 embodiments, wherein the depth of the channels is about 30 μm to about 50 μm.

A 4^{th} embodiment is any combination of the first 3 embodiments, wherein the depth of the channels is about 35 μm to about 43 μm.

A 5^{th} embodiment is any combination of the first 4 embodiments, wherein the laminate has a haze of about 0.8% to about 0.9% as measured by ASTM D1003.

A 6^{th} embodiment is any combination of the first 5 embodiments, wherein the laminate has light transmission of about 85% to about 90% as measured by ASTM D1003.

A 7^{th} embodiment is any combination of the first 6 embodiments, further comprising a second layer of glass, wherein the interlayer film is positioned between the first and second layers of glass.

An 8^{th} embodiment is any combination of the first 7 embodiments, wherein the film further comprises a second surface opposite the first surface, wherein the second surface has an embossed surface pattern having at least two channels extending in at least two non-parallel directions, the channels having a depth of greater than about 20 μm.

A 9^{th} embodiment is any combination of the first 8 embodiments, wherein the film comprises a non-plasticized thermoplastic material.

A 10^{th} embodiment is any combination of the first 9 embodiments, wherein the film comprises thermoplastic polyurethane (TPU).

An 11^{th} embodiment is any combination of the first 10 embodiments, wherein the film comprises ethylene vinyl acetate (EVA).

A 12^{th} embodiment is any combination of the first 11 embodiments, wherein the two channels are substantially perpendicular to each other.

A 13^{th} embodiment is any combination of the first 12 embodiments, further comprising a first plurality of channels extending in a first direction and a second plurality of channels extending in a second direction that is non-parallel to the first direction, wherein the channels within the first plurality of channels are spaced from each other by a distance of about 100 μm to about 1,000 μm.

A 14^{th} embodiment is any combination of the first 13 embodiments, wherein the laminate comprises a safety glass laminate.

In another aspect, a glass is provided comprising the laminate of any combination of the first 14 embodiments.

In another aspect, a window glazing is provided comprising the laminate of any combination of the first 14 embodiments.

In another aspect, a first embodiment is a method of manufacturing an interlayer film. The method comprises forming an embossment pattern on a calendar roll and transferring the embossment pattern to a surface of an interlayer film such that the surface has at least two channels extending in at least two non-parallel directions. The channels have a depth of greater than about 20 μm.

A second embodiment is the first embodiment, wherein the interlayer film comprises a second surface opposite the first surface, the method further comprising transferring the embossment pattern onto the second surface.

A 3^{rd} embodiment is any combination of the first 2 embodiments, further comprising placing the optical interlayer film between first and second sheets of glass to obtain a laminated structure and vacuum laminating the laminate structure.

A 4^{th} embodiment is any combination of the first 3 embodiments, wherein the calendar roll is a metal roll.

A 5^{th} embodiment is any combination of the first 5 embodiments, wherein the channels have a depth of greater than about 30 μm.

A 6^{th} embodiment is any combination of the first 5 embodiments, wherein the channels have a depth of about 35 μm to about 43 μm.

A 7^{th} embodiment is any combination of the first 6 embodiments, wherein the interlayer film comprises a non-plasticized thermoplastic material.

An 8^{th} embodiment is any combination of the first 7 embodiments, wherein the interlayer film comprises thermoplastic polyurethane (TPU).

A 9^{th} embodiment is any combination of the first 8 embodiments, wherein the film comprises ethylene vinyl acetate (EVA).

In another aspect, an interlayer film is provided formed from any combination of the first 9 embodiments.

In another aspect, a laminate is provided formed from any combination of the first 9 embodiments.

In another aspect, a window glazing is provided formed from any combination of the first 9 embodiments.

What is claimed is:

1. An optical interlayer film comprising at least one surface having an embossed surface pattern having at least two channels extending in at least two non-parallel directions, the channels having a depth greater than about 20 μm.

2. The film of claim 1, wherein the depth of the channels is greater than about 30 μm.

3. The film of claim 1, wherein the depth of the channels is about 30 μm to about 50 μm.

4. The film of claim 1, wherein the depth of the channels is about 35 μm to about 43 μm.

5. The film of claim 1, wherein the channels have a width of about 30 μm to about 900 μm.

6. The film of claim 1, wherein the channels are formed from one or more projections extending from the surface and one or more depressions extending into the surface, wherein a distance between a peak of the projections and a lowest point of the depressions is greater than about 20 μm.

7. The film of claim 1, wherein the channels have a width of about 400 μm to about 600 μm.

8. The film of claim 1, wherein the film comprises one of a non-plasticized thermoplastic material, a thermoplastic polyurethane (TPU) or an ethylene vinyl acetate (EVA).

9. The film of claim 1, further comprising a second surface opposite the first surface, wherein the second surface has an embossed surface pattern having at least two channels extending in at least two non-parallel directions, the channels having a depth greater than about 20 μm.

10. The film of claim 1, wherein the film has a thickness of less than about 0.08 inches.

11. The film of claim 1, wherein the film has a thickness of less than about 0.02 inches.

12. The film of claim 1, wherein the two channels are substantially perpendicular to each other.

13. The film of claim 1, further comprising a first plurality of channels extending in a first direction and a second plurality of channels extending in a second direction that is non-parallel to the first direction, wherein the channels within the first plurality of channels are spaced from each other by a distance of about 100 μm to about 1,000 μm.

14. A laminate comprising:
at least one layer of glass; and
an interlayer film comprising at least one surface having an embossed surface pattern having at least two channels extending in at least two non-parallel directions, the channels having a depth greater than about 20 μm prior to lamination.

15. The laminate of claim 14, wherein the depth of the channels is greater than about 30 μm.

16. The laminate of claim 14, wherein the depth of the channels is about 30 μm to about 50 μm.

17. The laminate of claim 14, wherein the laminate has a haze of about 0.8% to about 0.9% as measured by ASTM D1003.

18. The laminate of claim 14, wherein the laminate has light transmission of about 85% to about 90% as measured by ASTM D1003.

19. The laminate of claim 14, further comprising a second layer of glass, wherein the interlayer film is positioned between the first and second layers of glass and wherein the film further comprises a second surface opposite the first surface, wherein the second surface has an embossed surface pattern having at least two channels extending in at least two non-parallel directions, the channels having a depth greater than about 20 μm.

20. The laminate of claim 14, wherein the film comprises one of a non-plasticized thermoplastic material, a thermoplastic polyurethane (TPU) or an ethylene vinyl acetate (EVA).

21. The laminate of claim 14, wherein the two channels are substantially perpendicular to each other.

22. The laminate of claim 14, further comprising a first plurality of channels extending in a first direction and a second plurality of channels extending in a second direction that is non-parallel to the first direction, wherein the channels within the first plurality of channels are spaced from each other by a distance of about 100 μm to about 1,000 μm.
